(19) United States
(12) Patent Application Publication
(10) Pub. No.: US 2016/0294651 A1
(43) Pub. Date: Oct. 6, 2016

(54) METHOD, APPARATUS, AND COMPUTER PROGRAM PRODUCT FOR MONITORING AN ELECTRONIC DATA EXCHANGE

(71) Applicant: McKesson Corporation, San Francisco, CA (US)

(72) Inventor: Michael Renna, Atlanta, GA (US)

(21) Appl. No.: 14/674,059

(22) Filed: Mar. 31, 2015

(51) Int. Cl. H04L 12/26; H04L 29/08

(52) U.S. Cl. CPC H04L 43/06; H04L 67/06

(57) ABSTRACT

A method, computer program product and apparatus are provided for monitoring an electronic data exchange between a client and a servicing system. Inbound files from various types of agents may be received on the servicing system. Data collectors or listeners detect the transfer of data. A monitoring apparatus may collectively detect and track all data processing activities within the servicing systems. Profiles including expected processing activities based on the client or file type may be verified against tracking records of actual processing activities. The monitoring apparatus may therefore proactively monitor and initiate notifications in the event expected data processing activities do not occur or expected received files are not received in a specified time period.

### TECHNOLOGICAL FIELD

Embodiments of the present invention relate generally to computer technology and, more particularly, to methods, apparatuses, and computer program products for monitoring an electronic data exchange.

### BACKGROUND

The widespread use of modern computing technology has led to an increase in electronic data. Specialized providers offering services related to the processing of data, record keeping, analytics, payment processing, and/or the like has resulted in large scale electronic data transmissions amongst systems. In many cases, distributed systems require accurate and timely data to be transmitted to process the data as desired for a client.

Electronic data interchange (EDI) is a known concept by which systems exchange data in a standardized format. In some examples, the recipient system of data over an EDI reacts upon receiving inbound files and data by performing a variety of data transformation operations. The recipient or processing system therefore processes the data upon receipt and provides the resultant product or transformed data to the client, or transmits the output to the appropriate subsystem or party. The increase of sophisticated distributed systems and data processing methods paired with the increasing volume of electronic data may make it difficult for systems to verify that all expected EDI data has been received, and may further result in the desired output not being delivered as expected.

### BRIEF SUMMARY OF SOME EXAMPLE EMBODIMENTS

A method, computer program product and apparatus for monitoring an electronic data exchange are therefore provided. Example embodiments provide a centralized means for monitoring activity and communication amongst a variety of agents and data collectors. In general, the embodiments provided herein proactively monitor data processed over an EDI based on what the system expects to receive from a client, as documented in a profile. Tracking records store details of incoming and outgoing files and the stages that they follow. As information is collected, embodiments can provide proactive notification when something is not received or does not advance properly through the tracked stages. Embodiments additionally provide dashboards reflecting the health of such exchanges and track all in a file lifecycle.

A method is provided for monitoring an electronic data exchange between a client and a servicing system. The method comprises loading a profile comprising information describing expected files to be received during a defined period and logging information regarding receipt of files during the defined period in a tracking record. The method further includes comparing the tracking record to the profile, and in an instance an expected file is not received during the defined period, generating a notification.

The method may further include generating the profile by receiving user input describing the expected receipt, processing, and contents of a specified type of file, and applying the user input to a template such that the profile is stored in a memory of the serving system.

In some embodiments, the profile comprises an expected number of files of a given type to be received during the defined period, and the method further includes, in an instance a number of received files of the given type does not match the expected number of files of the given type, generating a mismatch notification. In some examples, the profile indicates an expected order of files to be processed, and the method further includes, in an instance files are not received in the expected order, generating an unexpected order notification.

In some examples, the method further includes calculating a deadline for a reactive process to occur in association with at least one received file and based on the profile, and in response to the deadline elapsing with no occurrence of the reactive process, generating a process failure notification.

The method may also include storing a plurality of tracking records in association with the identified profile, and generating reports describing the plurality of tracking records. In some examples, logging the information regarding receipt of files in the tracking record occurs in response to receiving an indication generated by an intermediary data collector configured at least for listening to a plurality of agents. The agents comprise at least one of a file transfer protocol engine, file manager, or conversion interface.

An apparatus is also provided for monitoring an electronic data exchange between a client and a servicing system. The apparatus comprises processing circuitry configured to cause the apparatus to perform at least loading a profile comprising information describing expected files to be received during a defined period and logging information regarding receipt of files during the defined period in a tracking record. The processing circuitry may also be configured to cause the apparatus to perform comparing the tracking record to the profile, and in an instance an expected file is not received during the defined period, generating a missing file notification.

A computer program product is also provided for monitoring an electronic data exchange between a client and a servicing system. The computer program product comprises at least one non-transitory computer-readable medium having computer-readable program instructions stored therein with the computer-readable program instructions comprising instructions, which when performed by an apparatus, are configured to cause the apparatus to perform at least loading a profile comprising information describing expected files to be received during a defined period and logging information regarding receipt of files during the defined period in a tracking record. The computer-readable program instructions are also configured to perform comparing the tracking record to the profile, and in an instance an expected file is not received during the defined period, generating a missing file notification.

An apparatus is also provided for monitoring an electronic data exchange between a client and a servicing system. The apparatus comprises means for loading a profile comprising information describing expected files to be received during a defined period and means for logging information regarding receipt of files during the defined period in a tracking record. The apparatus may also include means for comparing the tracking record to the profile, and means for generating a missing file notification in an instance an expected file is not received during the defined period.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIGS. 1 and 2 are block diagrams of a system used in the monitoring of an EDI, according to some example embodiments;

FIG. 3 is a block diagram of an apparatus configured for monitoring an EDI, according to some example embodiments;

FIG. 4 is an architectural model of a system used in the monitoring of an EDI, according to some example embodiments; and

FIGS. 5, 6 and 7 are flowcharts of operations for monitoring an EDI, according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, where a computing device is described to receive data from another computing device, it will be appreciated that the data may be received directly from the other computing device and/or may be received indirectly via one or more intermediary computing devices, such as, for example, one or more servers, relays, routers, network access points, and/or the like. Similarly, where a computing device is described herein to transmit data to another computing device, it will be appreciated that the data may be sent directly to the other computing device or may be sent to the other computing device via one or more interlinking computing devices, such as, for example, one or more servers, relays, routers, network access points, and/or the like.

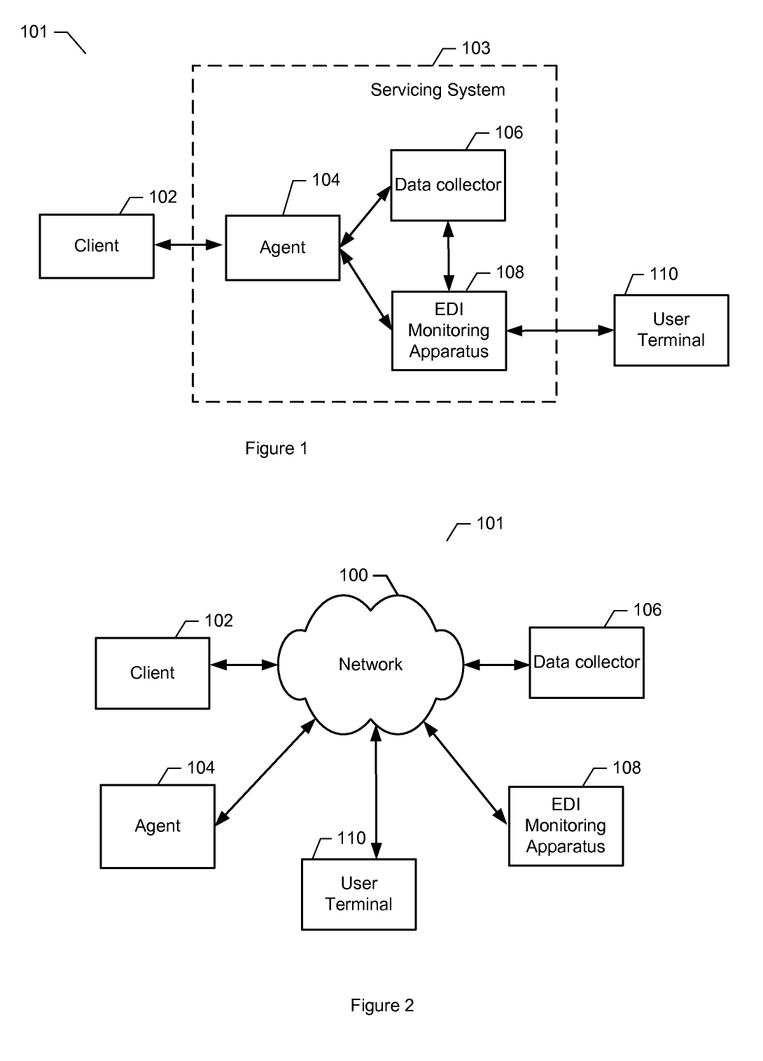

FIGS. 1 and 2 illustrate a system 101 according to some example embodiments. It will be appreciated that the system 101, as well as the illustrations in other figures, are each provided as an example of an embodiment(s) and should not be construed to narrow the scope or spirit of the disclosure in any way. In this regard, the scope of the disclosure encompasses many potential embodiments in addition to those illustrated and described herein. As such, while FIGS. 1 and 2 illustrate example configurations of a system, numerous other configurations may also be used to implement embodiments of the present invention.

As illustrated in FIG. 1, any number of client systems, or clients 102, may rely on a servicing system 103 for providing a variety of services, such as payment processing, purchase order processing, data reconciliation, inventory management, and/or the like. For example, client 102 may transmit purchase information to the servicing system 103. The servicing system 103 may provide a variety of services based on the purchase information, such as fulfilling orders by generating shipments to customers, and/or generating requests to other systems to replenish inventories. In some examples, servicing system 103 transmits data, such as the output of any processing of inbound files, back to the originating client 102. The above description is provided merely as an example and it will be appreciated that embodiments provided herein may be used in various industries and for a variety of applications.

The client 102 may, in some embodiments, be considered a third party system. The term ‘third party’ may be used to emphasize that the client 102 may operate independently from servicing system 103, and/or under different ownership than that of the servicing system 103, but it will be appreciated that in some embodiments, the client 102 may indeed be operated, separately, but nonetheless by the same entity in control of the servicing system 103.

In some examples, data transmitted between client 102 and the servicing system 103 may occur via an agent 104 of the servicing system. An agent 104 may include a file transfer protocol (FTP) engine, file management systems, conversion or interface engine, and/or a variety of platforms. For example, Global File System (GFS) and MOVEit®, are known applications to facilitate the exchange of electronic data. Although illustrated as a part of servicing system 103, in some examples, the agent 104 may be implemented external to the servicing system 103.

While the agent 104 is configured to receive data from client 102 over an EDI, a data collector 106 of the servicing system 103 may include any application configured to listen for inbound data processed by the agent 104. In some embodiments, the data collector 106 may be further configured to manage subsequent processes to perform on the data including transformation, manipulation, conversion, validation, reporting, and/or the like. For example, the data collector 106 may include email queues, directory watchers, database queues (e.g., Structure Query Language or SQL), web services and/or the like. The roles of the agents 104 and data collector 106 are described in further detail hereinafter.

According to example embodiments, the servicing system 103 may also include an EDI monitoring apparatus 108. The EDI monitoring apparatus 108 may receive information from agents 104 and/or data collector 106 to ensure accurate and timely processing of requests from clients 102. In some embodiments, any of the components of the servicing system 103, such as agent(s) 104, data collector(s) 106 and/or EDI monitoring apparatus 108 may be implemented on the same device.

Whereas current implementations may rely on reactive monitoring of error logs and reports by users in support roles, the EDI monitoring apparatus 108 may proactively track the progress of file processes such that even the absence of an expected process is detected, and appropriate parties or subsystems may be notified. For example, some agents and/or data collectors may be configured to receive inbound files, and process them in response to receipt. If the format of the file does not meet the required standards for the servicing system 103 to process the file as intended, the agent 104 and/or data collector 106 may log error messages to an appropriate file. However, in some examples, such as when an expected inbound file from a particular client is not received by the agent, the agent 104 and/or data collector 106 may not be configured to detect an error state due to the reactive behavior of the applications.

The EDI monitoring apparatus 108, on the other hand, may be configured to proactively monitor the receipt and processing of files from various clients 102. When expected processes do not occur, the EDI monitoring apparatus 108 may detect the potential problems and alert other parties or systems accordingly. For example, some clients transmit files on a routine basis, and if a particular file type is not received as expected, the EDI monitoring apparatus 108 may generate notifications accordingly. As another example, if an inbound file is received by the servicing system 103, but does not undergo every planned stage of processing, the EDI monitoring apparatus 108 may detect such failures according to example embodiments provided herein. The methods, computer programs product, and apparatus for monitoring the EDI are described in further detail in accordance with example embodiments below.

In some embodiments, the EDI monitoring apparatus 108 may be further configured to communicate with a user terminal 110. User terminal 110 may be embodied as a user terminal such as a laptop computer, tablet computer, mobile phone, desktop computer, workstation, or other like computing device. User terminal(s) 110 may be used to access reports and dashboards provided by the EDI monitoring apparatus 108, and/or to access maintenance tools, web applications, or other user interfaces for administration of the EDI monitoring apparatus 108. As such, in example embodiments, administrators, analysts, or users in similar roles supporting the servicing system 103 may use user terminal 110 to ensure ongoing maintenance of the EDI monitoring apparatus 108 and facilitate positive customer service to the servicing system's customers and associated clients. Any number of user terminals 110 may be present in system 101. The various functions provided by the EDI monitoring apparatus 108 for enabling user interaction on a user terminal are described in further detail hereinafter.

FIG. 2 is another block diagram illustration of system 101. As illustrated in FIG. 2, client(s) 102, agent(s) 104, data collector(s) 106, EDI monitoring apparatus 108, and/or a user terminal 110 may communicate over network 100.

Network 100 may be embodied in a local area network, the Internet, any other form of a network, or in any combination thereof, including proprietary private and semi-private networks and public networks. The network 100 may comprise a wired network, wireless network (e.g., a cellular network, wireless local area network, wireless wide area network, some combination thereof, or the like), or a combination thereof, and in some example embodiments comprises at least a portion of the Internet. In some examples, network 100 may include an EDI configured to facilitate communication between a client 102 and servicing system 103.

In some example embodiments, any of the client 102, agent(s) 104, data collector(s) 106, and/or EDI monitoring apparatus 108, may be implemented as a distributed system or a cloud based entity that may be implemented within network 100. In this regard, client 102, agent(s) 104, data collector(s) 106, and/or EDI monitoring apparatus 108 may comprise one or more servers, a server cluster, one or more network nodes, a cloud computing infrastructure, some combination thereof, or the like.

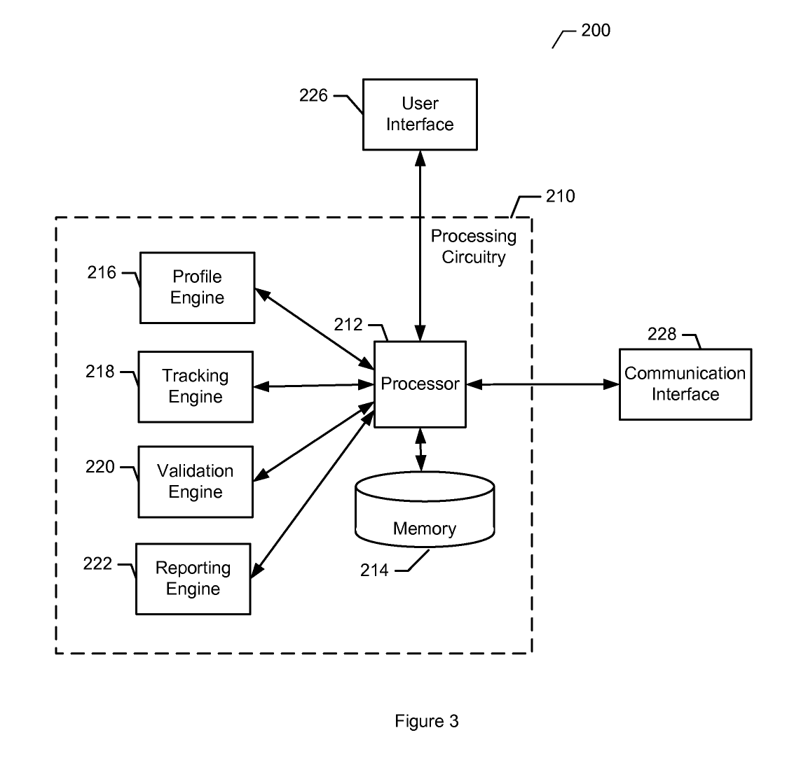

FIG. 3 illustrates an example apparatus 200 that may implement EDI monitoring apparatus 108 in accordance with some example embodiments. In some examples, the apparatus 200 may implement any of agent(s) 104, data collector(s) 106, and/or a user terminal 110. However, it should be noted that the components, devices, and elements illustrated in and described with respect to FIG. 3 below may not be mandatory and thus some may be omitted in certain embodiments. For example, FIG. 3 illustrates a user interface 226, as described in more detail below, which may be provided by the user terminal 110, but may be optional in the EDI monitoring apparatus 108 (although in such examples the EDI monitoring apparatus 108 may be configured to generate user interface displays for provision by a user interface 226 of the user terminal 110). Additionally, some embodiments may include further or different components, devices, or elements beyond those illustrated in and described with respect to FIG. 3.

Continuing with FIG. 3, processing circuitry 210 may be configured to perform actions in accordance with one or more example embodiments disclosed herein. In this regard, the processing circuitry 210 may be configured to perform and/or control performance of one or more functionalities of agent(s) 104, data collector(s) 106, EDI monitoring apparatus 108, and/or a user terminal 110 in accordance with various example embodiments. The processing circuitry 210 may be configured to perform data processing, application execution, and/or other processing and management services according to one or more example embodiments. In some embodiments, agents 104, data collector(s) 106, EDI monitoring apparatus 108, and/or a user terminal 110, or a portion(s) or component(s) thereof, such as the processing circuitry 210, may be embodied as or comprise a computing device, e.g., an integrated circuit or other circuitry. The circuitry may constitute means for performing one or more operations for providing the functionalities described herein.

In some example embodiments, the processing circuitry 210 may include a processor 212, and in some embodiments, such as that illustrated in FIG. 3, may further include memory 214. The processing circuitry 210 may be in communication with or otherwise control a user interface 226, and/or a communication interface 228. As such, the processing circuitry 210 may be embodied as a circuit chip (e.g., an integrated circuit) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of agent(s) 104, data collector(s) 106, EDI monitoring apparatus 108, and/or a user terminal 110 as described herein. The plurality of processors may be embodied on a single computing device or distributed across a plurality of computing devices collectively configured to function as agent(s) 104, data collector(s) 106, EDI monitoring apparatus 108, and/or a user terminal 110.

In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as agent(s) 104, data collector(s) 106, EDI monitoring apparatus 108, and/or a user terminal 110.

The memory 214 may be configured to store information, data, applications, instructions and/or the like for enabling agent(s) 104, data collector(s) 106, EDI monitoring apparatus 108, and/or a user terminal(s) 110 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 226, and/or communication interface 228, for passing information among components of agent(s) 104, data collector(s) 106, EDI monitoring apparatus 108, and/or a user terminal(s) 110.

In some example embodiments in which apparatus 200 is implemented as EDI monitoring apparatus 108, the processing circuitry 210 may further include any of a profile engine 216, tracking engine 218, validation engine 220, and/or reporting engine 222. In some examples, any of the aforementioned engines 216, 218, 220 and/or 222 may be implemented on processor 212. Engines 216, 218, 220 and/or 222 may therefore comprise processing means to provide the respective functionality of the EDI monitoring apparatus 108 as described below.

In general, the profile engine 216 enables the storage, maintenance, retrieval, and processing of profiles configured to store expectations for various file instances and the stages or steps of processing that should occur within the servicing system 103. For example, a profile may be configured for a particular client 102. As another example, a specific profile may be maintained for a specific platform which multiple clients may utilize. In some examples a profile may be designated for a specific file type or file extension.

The profile may include expectations for any type of file processing, and may be considered a file exchange definition. As data flows into the servicing system 103, information related to or describing the data may be compared to expectations in a profile so that the EDI monitoring apparatus 108 may validate the success of each process. Profiles may define the steps a file will follow, the timing and/or frequency of each instance, and a unique identifier for unique instances that are included in the profile.

The profile engine 216 may therefore generate a user interface for user configuration of profiles. For example, the profile engine 216 may provide templates to users such that the users may provide details regarding expectations of inbound files, the processing of the inbound files by the system 101, and/or contents of such files. The template and/or user interface may provide the underlying profile data in a user-readable format while the profile may additionally be formatted so as to be readable by computer program code for the purposes of validation, described in further detail hereinafter. In this regard, a profile may be implemented as a file or collection of files stored on memory 214.

While the profile engine 216 provides a definition of file processing activities expected to occur relative to a specific client, file type, platform, and/or the like, the tracking engine 218 tracks the progress of file processing activities and events that have indeed occurred or have been detected on servicing system 103. In some examples, receipt of an incoming file by an agent 104 may result in several stages or phases of processing by servicing system 103. The tracking engine 218 may, for example, record events, and/or each stage of processing in a tracking record along with timestamps or other details pertinent to successful tracking. A tracking record, or journal, may be stored on memory 214, and may include separate instances for each received file and/or may be configured to track the progress of more than one incoming file. A tracking record may even be used to map a lifecycle of each data file from receipt to archive, including any child files created throughout the various stages. In some examples, a profile and journal may be implemented within a single instance, therefore defining the file processing expectations and recording actual tracking of a particular incoming file.

Validation engine 220 may utilize the profile engine 216 and/or tracking engine 218 to determine whether expected processing or events as defined in various profiles are documented as having occurred in the associated tracking records. The validation engine 220 may therefore be triggered, such as by routine or otherwise scheduled validation processes, to validate a tracking record against an associated profile. For example, a particular profile may be accessed by the validation engine 220 on a periodic basis, such as hourly, daily, weekly, or the like. The validation engine 220 may be configured to interpret rules or data definitions with the profile such that the tracking record may be validated for successful and/or on time processing of data. The validation engine 220 may therefore identify incomplete processes or the absence of files expected to be received or processed by the servicing system 103. The validation engine 220 may therefore notify respective systems and/or components accordingly.

The user interface 226 may be in communication with the processing circuitry 210 to receive an indication of a user input at the user interface 226 and/or to provide an audible, visual, mechanical, or other output to the user. As such, the user interface 226 may include, for example, a keyboard, a mouse, a joystick, a display, a touch screen display, a microphone, a speaker, and/or other input/output mechanisms. As such, the user interface 226 may, in some example embodiments, provide means for user control of managing or processing data access operations and/or the like. In some example embodiments in which EDI monitoring apparatus 108 is embodied as a server, cloud computing system, or the like, aspects of user interface 226 may be limited or the user interface 226 may not be present. Accordingly, regardless of the implementation, the user interface 226 may provide input and output means in accordance with one or more example embodiments, such as displaying dashboards or administration screens for a user.

The communication interface 228 may include one or more interface mechanisms for enabling communication with other devices and/or networks. In some cases, the communication interface 228 may be any means such as a device or circuitry embodied in either hardware, or a combination of hardware and software that is configured to receive and/or transmit data from/to a network and/or any other device or module in communication with the processing circuitry 210. By way of example, the communication interface 228 may be configured to enable communication among client 102, agent 104, data collector 106, EDI monitoring apparatus 108, and/or user terminal 110 via network 100. Accordingly, the communication interface 228 may, for example, include supporting hardware and/or software for enabling wireless and/or wireline communications via cable, digital subscriber line (DSL), universal serial bus (USB), Ethernet, or other methods.

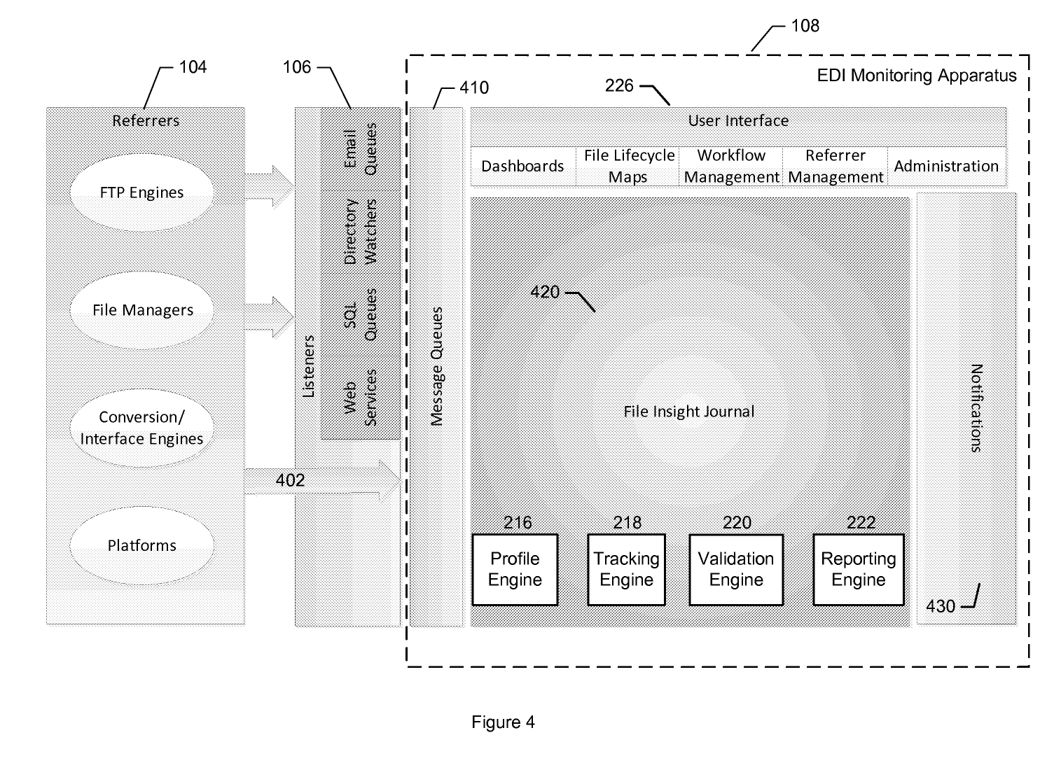

FIG. 4 is an architectural model of a system used in the monitoring of an EDI, according to some example embodiments. As described above, agents 104, or ‘referrers’ to the EDI monitoring system may receive incoming files from a client 102 (not shown). The agents 104 may be configured to feed messages to any of the data collectors 106, or ‘listeners.’ The EDI monitoring apparatus 108 can therefore monitor incoming files and any processes performed thereon, either directly from the data collectors 106, or by way of an intermediary message queue 410. In some examples, an agent may be configured to interface with the EDI monitoring apparatus 108 such as with the message queue 410 and as indicated by the lower arrow 402. The message queue 410 may provide a centralized means, such as a portion of memory 214, from which the EDI monitoring apparatus 108 may access information regarding incoming files and/or current processes of the servicing system 103. In this regard, the message queue 410 may receive information from a variety of sources such as agents 104 and/or data collectors 106, and store the information in a uniform format. The EDI monitoring apparatus 108 may then process the information, monitor the processes, and provide a user interface 226 and/or notifications 430 as described in more detail herein.

As illustrated in FIG. 4, file transfer protocol (FTP) engines, file managers, conversion or interface engines and/or platforms may transmit data to data collectors 106 and/or message queue 410. The EDI monitoring apparatus 108 may therefore be configured to monitor the exchange of data with a variety of types of agents. For example, FTP engines, such as Depot, MOVEit®, and/or Facts, may be configured to transfer electronic files from the client to the servicing system 103. File manager systems may provide user interfaces enabling users to move and/or edit files.

Conversion or interface engines may convert data from a client 102 to a format readable by the servicing system 103. For example, Cloverleaf® and other HL7 interface engines are specifically configured for healthcare provider legacy systems to enable integration of electronic health information with other systems and third party servicers in the healthcare industry.

As another example, specialized platforms or frameworks may be operative on client 102 or servicing system 103 for processing data. For example, MMIS (Medicaid Management Information Systems) is a specialized architecture for processing electronic health information in conjunction with the Medicaid program, and may interface with any of the data collectors 106 and/or EDI monitoring apparatus 108 to provide information regarding data or processes.

The wide array of implementations of agents 104 as well as respective methods of integration with the servicing system 103 results in a complex environment for monitoring incoming data to the servicing system 103 and processes occurring with the servicing system 103. The EDI monitoring apparatus 108 therefore may not rely on a single means of monitoring all incoming data to the servicing system 103. Rather, the EDI monitoring apparatus 108 collectively monitors the agents 104, such as with a variety of methods, including utilizing data collectors 106, or ‘listeners.’

For example, as shown in FIG. 4, data collectors 106, also referred to as listeners, may detect an inbound file or data from any of the above described agents. The agents may generate messages relating to the incoming data in a predefined format and transmit the messages to an email inbox. The EDI monitoring apparatus 108 may then parse email messages to determine information relating to the received data, and associated processing methods performed within the servicing system 103. In some examples, the information from the parsed email message may be inserted into the message queue 410.

As another example, an agent or referrer such as an FTP engine may be configured to transfer a file from one location to another, such as from a client to servicing system 103, but may not necessarily be configured to monitor or track the progress of the subsequent workflow or processing of the file. A directory watcher may therefore be used to monitor one or more folders for activity. In this scenario, the directory watcher may determine the action or stage that was completed based on target directories, filenames, timestamps, directory contents, and/or the like. The relevant information may be inserted into message queue 410 to be processed by the EDI monitoring apparatus 108. The EDI monitoring apparatus 108 may therefore monitor various directories such that notifications regarding incoming files or actions performed on incoming files are reporting to the tracking engine 218.

As yet another example shown in FIG. 4, a database table may serve as a queue, such as a structured query language (SQL) table. In this regard, any of the agents 104 may be configured to write data to a database table regarding incoming files or processing thereof. For example, the agent 104 may be configured to write to a database accessible by the servicing system 103 with standard database connectivity software, such as database connectivity (ODBC) or extensible markup language database connector (XDBC). The EDI monitoring apparatus 108 may then retrieve data from a table(s), such as by first-in-first out or other method, thereby utilizing the table as a message queue. The table may include, for example, records indicating a file name, file type, file size, timestamp and/or the like such that the EDI monitoring apparatus 108 may access the data as indications of received files and/or processing actions. The EDI monitoring apparatus 108 may provide the information to the tracking engine 218 to record the data in a tracking record or journal, for example.

As also illustrated in FIG. 4, various web services implemented within the servicing system 103 may be configured to provide indications of received and/or processed data. In some examples, the web services may be configured to provide specialized services for clients. In this regard, the servicing system 103 may further implement a web service to interface with the EDI monitoring apparatus 108. The web service may write information to message queue 410, for example.

According to some example embodiments, several of the components of the EDI monitoring apparatus 108 may be referred to as a file insight journal 420. As illustrated in FIG. 4, the file insight journal 420 may include the tracking engine 218, for retrieving messages from message queue 410, and writing information to the relevant tracking record or journal. For example, the tracking engine 218 may identify a uniquely identifying feature of a file or file process in the message queue and write the information to the appropriate tracking record. Any subsequent processes associated with the same file or data may therefore be tracked within the tracking record.

The profile engine 216, as described above, may comprise information describing the expected files and/or processes to be monitored. A profile may be configured in the profile engine 216 based on the input of a user. For example, a template may be provide for a user to complete, indicating pertinent information such as a client identifier, file name, contents, formatting, file size, time frame received, and/or frequency of receipt associated with inbound files. The setup of a profile may be a one-time configuration, and/or the profile may be maintained for ongoing use by the profile engine 216. In some examples, the profile engine 216 and tracking engine 218 may be configured to communicate such that tracking records are generated in advance of an expected receipt of a file.

The validation engine 220 may then validate the tracking records maintained by the tracking engine 218 relative to the profiles maintained by the profile engine 216, as described above. For example, if a profile associated with a particular client indicates a file with the name “File XYZ” should be received on a nightly basis between 9 pm and 11 pm, the validation engine 220 may perform a validation check at 11:05 pm. If determined based on the tracking records that the file has not be received that evening, the validation engine 220 may generate a missing file notification(s), such as notification 430, that may be transmitted to an appropriate end-user or user interface, such as indicated in the profile, for example. The notification may be an email message to a designated user, for example, or may generate a support ticket for a support group to monitor and resolve.

For example, the validation engine 220 may track the time between the receipt of a specific type of file and transition of data from one stage to another. If an expected subsequent action does not occur within a predefined threshold, the validation engine 220 may generate a process failure notification accordingly.

Still further, the validation engine 220 may notify profile owners or other users when any stage of a process cannot be validated within a defined period of time. For example, if an expected file is not received from a client within 24 hours from expected arrival, an email can be sent to a distribution group and the profile instance can be moved to a failed state requiring action. As another example, a mismatch notification may indicate that a file type of a received file is a different type than expected.

As another example, a notification may include alerts when duplicate files are received. Additional notifications may be defined based on information such as placement values and numbers against an acceptable contract variance. To achieve this, profiles may receive or store specific measures and allowable variances.

It will be appreciated that any number of notification types may be generated or provided. Notification types may include, for example, a missing file notification, a mismatch notification, an unexpected order notification, and/or a process failure notification. A missing file notification may be generated in an instance an expected file is not received during the defined period. A mismatch notification may be generated in an instance a number of received files of the given type does not match the expected number of files of the given type. An unexpected order notification may be generated in an instance files are not received in the expected order. A process failure notification may be generated in response to the deadline elapsing with no occurrence of the reactive process.

While the validation engine 220 proactively monitors the flow of data into the servicing system 103 and data processes within the system, the reporting engine 222 may provide dashboards of the overall health of the servicing system 103 and its receipt and processing of data from clients via user interface 226. The dashboards may be provided to users on demand, and may be configurable so that the user may view dashboards relating to a particular client, process, file type, and/or the like. The dashboards may cover an extended period of time to provide a high-level view of performance.

Dashboards may additionally provide “at-a-glance” indicators such as red-light/green-light indicators, and represent that health of a client, platform or individual profile instance. Agents or platforms may be grouped such that users can view overall health of systems or areas and identify patterns in problematic processes, or highlight particularly efficient processes. In some examples, a user may view client or platform specific data or may drill down to the profile level or specific file or process related tracking records and/or the like.

As shown in FIG. 4, in addition to dashboards, the user interface 226 may provide file lifecycle maps, workflow managements, referrer management, and/or administration functionality. The file lifecycle maps may include a visual representation of the various stages an incoming file goes through before the desired output or end result is generated. In some examples, the file lifecyle maps may be generated from data stored in the profiles.

Workflow management may provide a user interface enabling a user to modify or provide information to the EDI monitoring apparatus 108 relating to the expected processes, data transformation, and/or transition from one stage in a process to another.

User interface 226 may additionally provide a referrer or agent management component. This enables users to configure the EDI monitoring apparatus 108 to configure agents 104 to accurately communicate inbound files to the EDI monitoring apparatus 108. For example, a new agent or file transfer services may be introduced to system 101, requiring that the EDI monitoring apparatus 108 is configured to monitor the service, such as by directing the agent 104 to report to the message queue 410 or provide data in a format interpretable by any of the data collectors 106, for example. A user may access the referrer management component to configure the EDI monitoring apparatus 108 accordingly.

Furthermore, user interface 226 may include a component for general administration of the system, such as registering users to access particular dashboards, and/or modifying or adding profiles to the profile engine 216. For example, if a client's needs change that will affect the EDI of the client's data to the servicing system 103, a user may reconfigure a profile to reflect the changes. In some examples, only specific users may be authorized to do so, as indicated by the administration component.

The architectural diagram described above with respect to FIG. 4 is provided as an example and it will be appreciated that other implementations of the EDI monitoring apparatus 108 and/or system 101 may be provided.

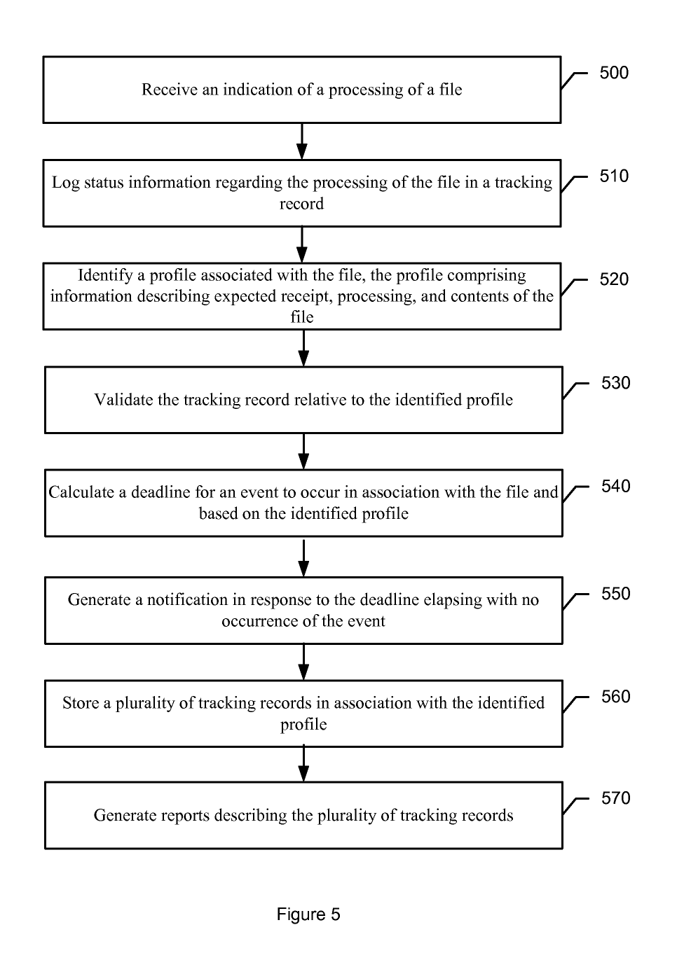

FIG. 5 is a flowchart illustrating operations of the EDI monitoring apparatus 108 according to example embodiments. In particular, the flowchart of FIG. 5 illustrates operations for monitoring expected processes within the servicing system 103. As shown by operation 500, the EDI monitoring apparatus 108 may include means, such as communication interface 228, tracking engine 218, processor 212, memory 214, and/or the like, for receiving an indication of a processing of a file.

In this regard, processing of a file may include any of receipt of a file on the servicing system 103 from a client 102, for example. The processing may additionally or alternatively include any transformation, conversion, file name changing, archiving, and/or the like of the received data. For example, a file comprising purchase order data may be transformed into any number of files such as one defining a shipping order to a customer, and inventory replenishment at a warehouse. As another example, an inbound file comprising insurance claim data may result in generation of an electronic funds transfer from a payor to payee by the servicing system 103. Therefore, any action or process performed by the servicing system 103 where the file or data therein is provided as an input, may be considered as processing of the file.

Furthermore, with regard to the indication referred to in operation 500, the indication of the processing of the file may include any indication generated by, detected by, or received from any agents 104, data collectors 106, or message queue 410. In some instances, the indication may be generated from a plurality of communications or message transmissions occurring between any of the agents 104, data collectors 106, or message queue 410. In some examples, processing of the file may include transmitting an output of a process to the client 102 or other subsystem of system 101, such as another third party system.

As shown by operation 510, the EDI monitoring apparatus 108 may include means, such as tracking engine 218, processor 212, memory 214, and/or the like, for logging status information regarding the processing of the file in a tracking record. In some examples, a tracking record(s) may be generated for each expected instance of a received file by the servicing system 103. In some embodiments, the tracking record instance may be generated in advance of receipt, based on the information in the profile(s).

As described above, the tracking engine 218 may record any pertinent information relating to the file in tracking record, log, or journal. As an example, a tracking record may indicate the date and time a file was received on the servicing system 103, the source or client initiating the transmission, or the size of the file. Every phase or stage that a file undergoes within the servicing system 103 may be tracked accordingly. For example, a file may be transferred from client 102 to memory 214 by an FTP engine. The file transfer may be recorded as one action on a tracking record. Once copied to memory 214, an agent 106 such as a custom directory watcher of the servicing system 103 may detect the presence of the file in a particular directory, and cause the tracking engine 218 to write information to the tracking record. Other subsystems and/or components of the servicing system 103 may act on the file, such as by calling a web service of the servicing system. Information regarding the processing of the data by the web service may in turn be logged to the same tracking record.

In some embodiments, as shown by operation 520, the EDI monitoring apparatus 108 may include means, such as profile engine 216, processor 212, memory 214, and/or the like, for identifying a profile associated with the file. As described above, the profile may comprise information describing expected receipt of the file, expected action or processing of the file, and/or contents of the file. In some examples operation 520 may occur simultaneously and/or asynchronously from operation 510. The profile engine 216 may for example, identify a stored profile associated with the file being processed by the servicing system 103. The file may be identified based on the client from which the file originated, by the file name, or any other information regarding the file. As described above, the identified profile may comprise any information describing the expected receipt (e.g., time frame, frequency), expected subsequent actions or processing on the file, or contents (e.g., format, size). In some examples, the expected action or processing may include a synchronous and/or reactive process that occurs in response to receipt of a file or other action, as opposed to a batch process, scheduled job, and/or process that may occur automatically or independently of a receipt of a file, other action, or notification thereof. Said differently, the expected action stored in the profile may be a synchronous process that occurs in response to another action and/or reactively to another action, such as receipt of the file by the servicing system 103 and/or an outcome of another process. The expected subsequent action or processing may therefore be considered a non-routine or non-scheduled job.

As such, continuing to operation 530, the EDI monitoring apparatus 108 may include means, such as validation engine 220, processor 212, memory 214 and/or the like, for validating the tracking record relative to the identified profile. Based on expectations recorded in the profile, such as expected times and frequency of inbound files, or expected times and frequency of offshoot and/or synchronous processes initiated based on receipt of a file from a client, the validation engine 220 may validate the tracking record to ensure the expected events have actually occurred. As described above, validation processes may be initiated based on times files were received, or expected times the next stage or action is expected to occur.

For example, as shown by operation 540, the EDI monitoring apparatus 108 may include means, such as validation engine 220, processor 212, memory 214 and/or the like, for calculating a deadline for an event to occur in association with the file and based on the identified profile. As shown by operation 550, the EDI monitoring apparatus 108 may include means, such as validation engine 220, processor 212, memory 214 and/or the like, for generating a notification, such as a process failure notification, in response to the deadline elapsing with no occurrence of the event.

In some embodiments, as shown by operation 550, the EDI monitoring apparatus 108 may include means, such as tracking engine 218, processor 212, memory 214 and/or the like, for storing a plurality of tracking records in association with the identified profile. In this regard, the EDI monitoring apparatus 108 may provide comprehensive records of all data exchange and file processes occurring on the servicing system 103.

As such, as shown by operation 570, the EDI monitoring apparatus 108 may include means, such as reporting engine 222, processor 212, memory 214 and/or the like, for generating reports or dashboards describing the plurality of tracking records. As described above, this enables the EDI monitoring apparatus 108 to provide information regarding the overall heath or performance of the servicing system 103 with regard to its EDI with clients and the subsequent processing of the inbound data.

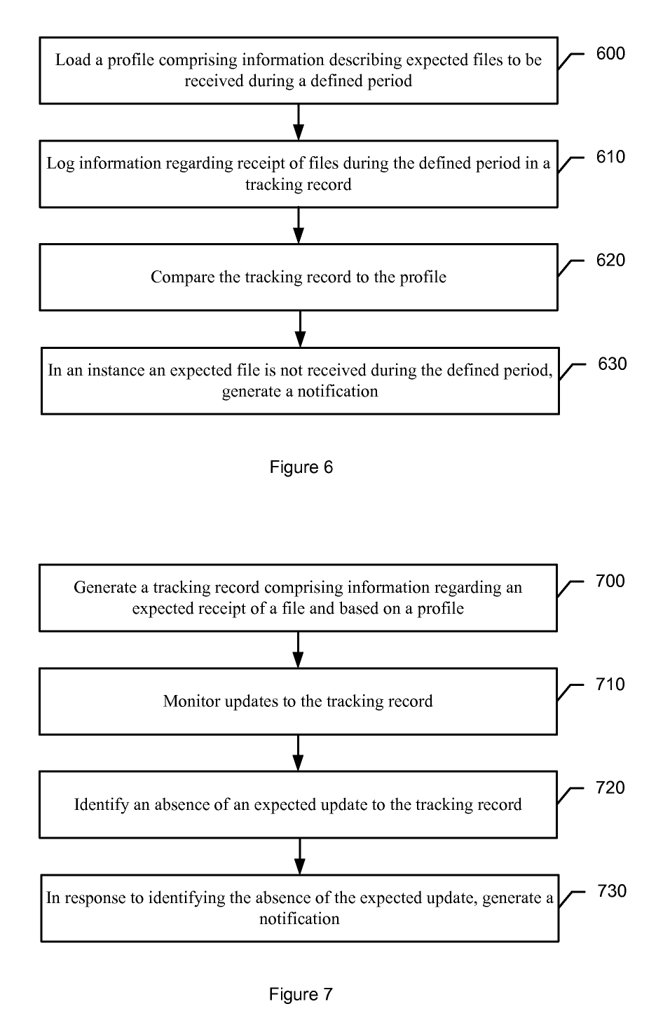

FIG. 6 is another flowchart illustrating operations of the EDI monitoring apparatus 108 according to example embodiments. As shown by operation 600, the EDI monitoring apparatus 108 may comprise means, such as profile engine 216, processor 212, memory 214, and/or the like, for loading a profile comprising information describing expected files to be received during a defined period. As described above, the profile may be generated by the EDI monitoring apparatus 108 by applying user input describing the expected receipt, processing, and contents of a specified type of file to a template such that the profile is stored in memory 214, for example. The profile may include information regarding expected files during a defined period (e.g., between a start time and/or end time, and on a frequency, such as daily or weekly, for example). The file may, for example, indicate an expected number of files of a given type to be received, or an expected order of files to be received.

As shown by operation 610, the EDI monitoring apparatus 108 may comprise means, such as tracking engine 218, processor 212, memory 214, and/or the like, for logging information regarding receipt of files during the defined period in a tracking record. For example, information regarding receipt of the files may be performed in accordance with operation 510 above.

As shown by operation 620, the EDI monitoring apparatus 108 may comprise means, such as validation engine 220, processor 212, memory 214, and/or the like, for comparing the tracking record to the profile. For example, the comparison may be performed in accordance with the validation as described above with respect to operation 530.

As another example, a tracking record generated in advance of an expected process or expected receipt of a file may indicate an expected timeframe or period in which a file should be received. A lack of information in a tracking record, such as after expiration of the defined period may indicate that an expected file has not been received by the servicing system 103. Therefore in such an example, the tracking record need not necessarily be compared against the profile, but rather processed independently of the profile such that the validation engine 220 determines an expected process or file transmission has not occurred. An embodiment in which the tracking record is generated in advance of an expected process or expected receipt of a file is described in further detail with respect to FIG. 7.

Continuing with FIG. 6, whether the tracking record is validated independently of the profile, or in comparison to the profile, as shown by operation 630, the EDI monitoring apparatus 108 may comprise means, such as validation engine 220, processor 212, memory 214, communication interface 228 and/or the like, for generating a missing file notification in an instance an expected file is not received during the defined period.

FIG. 7 illustrates example operations of the EDI monitoring apparatus 108 according to an example embodiment. As shown in FIG. 7, operation 700, the EDI monitoring apparatus 108 may comprise means, such as profile engine 216, tracking engine 218, processor 212, memory 214 and/or the like, for generating a tracking record comprising information regarding an expected receipt of a file and based on a profile. As mentioned above, a tracking record instance may be generated in advance of an expected received file based on a profile. For example, if a profile indicates a particular type of file is expected to be received on a particular day between 9 pm and 11 pm, the EDI monitoring apparatus 108 may generate a tracking record instance prior to 9 pm on the particular day.

As shown by operation 710 the EDI monitoring apparatus 108 may comprise means, such as tracking engine 218, validation engine 220, processor 212, memory 214, and/or the like, for monitoring updates to the tracking record. For example, the EDI monitoring apparatus 108 may check the last update time or information written to a tracking record, on a predetermined time interval, such as every 15 minutes, for example.

As shown by operation 720, the EDI monitoring apparatus 108 may comprise means, such as tracking engine 218, validation engine 220, processor 212, memory 214, and/or the like, for identifying an absence of an expected update to the tracking record. For example, if the tracking record indicates a file was expected to be received between 9 pm and 11 pm, and at 11:15 pm the EDI monitoring apparatus 108 detects that information regarding the expected received file has not been written to the tracking record, the EDI monitoring apparatus 108 identifies the lack of information as an absence of an expected update to the tracking record and therefore a lack of receipt of the expected file.

As shown by operation 730, the EDI monitoring apparatus 108 may comprise means, such as validation engine 220, processor 212, memory 214, and/or the like, for generating a notification in response to identifying the absence of the expected update.

Embodiments provided herein therefore provide a proactive system for monitoring the EDI between client 102 and the servicing system 103 and processing occurring within the servicing system 103. As opposed to reactive implementations which detect only exceptions, and specific error handlers configured to report failed processes based on improperly formatted data, the EDI monitoring apparatus 108 accesses detailed profiles describing expected processes, and logs detailed records of received data and various stages of processing. The EDI monitoring apparatus 108 may therefore proactively validate the actual processes detailed in tracking records compared to expected processes defined in the profiles.

Moreover, enabling user configuration of a profile via a user interface and/or templates may result in a change in pattern of generating tracking record instances, providing for easy updates and modifications based on changing client needs.

Example embodiments therefore enable the servicing system 103 to be notified of potential issues and resolve the issues prior to detection by the various clients, thereby improving client relationships and customer service.

Furthermore, embodiments provided herein provide numerous technical advantages including the conservation of processing resources and the associated power consumption otherwise expended to support access to all the components of the servicing system 103, such as required by a troubleshooting. For example, a support technician may have to manually review or assess activities on a long list of agents 104 and data collectors 106. For example, a user may otherwise need to export directory contents and archived snapshots of directories to a spreadsheet application or similar, and manipulate and organize the data to discover disrupted patterns or flaws in data processing services. Such methods require significantly more processing power and memory capacity than the methods, computer program products, and apparatuses provided herein. The EDI monitoring apparatus 108 as described herein provides efficient and proactive monitoring of a variety of configurations of agents and data collectors, with a centralized component or module, thereby minimizing the use of processing resources compared to alternative implementations and introducing significant improvements to EDIs.

FIGS. 5, 6 and 7 illustrate operations of a method, apparatus, and computer program product according to some example embodiments. It will be understood that each operation of the flowcharts or diagrams, and combinations of operations in the flowcharts or diagrams, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, memory 214) storing instructions executable by a processor in the computing device (for example, by processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, EDI monitoring apparatus 108) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, EDI monitoring apparatus 108, and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for monitoring an electronic data exchange between a client and a servicing system, the method comprising:
loading a profile comprising information describing expected files to be received during a defined period;
logging information regarding receipt of files during the defined period in a tracking record;
comparing the tracking record to the profile; and
in an instance an expected file is not received during the defined period, generating a missing file notification.

2. The method of claim 1, further comprising:
generating the profile by receiving user input describing the expected receipt, processing, and contents of a specified type of file; and
applying the user input to a template such that the profile is stored in a memory of the serving system.

3. The method of claim 1, wherein the profile comprises an expected number of files of a given type to be received during the defined period, and the method further comprises:
in an instance a number of received files of the given type does not match the expected number of files of the given type, generating a mismatch notification.

4. The method of claim 1, wherein the profile indicates an expected order of files to be processed, and the method further comprises:
in an instance files are not received in the expected order, generating an unexpected order notification.

5. The method of claim 1, further comprising:
calculating a deadline for a reactive process to occur in association with at least one received file and based on the profile; and
in response to the deadline elapsing with no occurrence of the reactive process, generating a process failure notification.

6. The method of claim 1, further comprising:
storing a plurality of tracking records in association with the identified profile; and
generating reports describing the plurality of tracking records.

7. The method of claim 1, wherein logging the information regarding receipt of files in the tracking record occurs in response to receiving an indication generated by an intermediary data collector configured at least for listening to a plurality of agents, the agents comprising at least one of a file transfer protocol engine, file manager, or conversion interface.

8. An apparatus for monitoring an electronic data exchange between a client and a servicing system, the apparatus comprising processing circuitry configured to cause the apparatus to perform at least:
loading a profile comprising information describing expected files to be received during a defined period;
logging information regarding receipt of files during the defined period in a tracking record;
comparing the tracking record to the profile; and
in an instance an expected file is not received during the defined period, generating a missing file notification.

9. The apparatus of claim 8, wherein the processing circuitry is further configured to cause the apparatus to perform at least:
generating the profile by receiving user input describing the expected receipt, processing, and contents of a specified type of file; and
applying the user input to a template such that the profile is stored in a memory of the serving system.

10. The apparatus of claim 8, wherein the profile comprises an expected number of files of a given type to be received during the defined period, and the processing circuitry is further configured to cause the apparatus to perform at least:
in an instance a number of received files of the given type does not match the expected number of files of the given type, generating a mismatch notification.

11. The apparatus of claim 8, wherein the profile indicates an expected order of files to be processed, and the processing circuitry is further configured to cause the apparatus to perform at least:
in an instance files are not received in the expected order, generating an unexpected order notification.

12. The apparatus of claim 8, wherein the processing circuitry is further configured to cause the apparatus to perform at least:
calculating a deadline for a reactive process to occur in association with at least one received file and based on the profile; and
in response to the deadline elapsing with no occurrence of the reactive process, generating process failure notification.

13. The apparatus of claim 8, wherein the processing circuitry is further configured to cause the apparatus to perform at least:
storing a plurality of tracking records in association with the identified profile; and
generating reports describing the plurality of tracking records.

14. The apparatus of claim 8, wherein logging the information regarding receipt of files in the tracking record occurs in response to receiving an indication generated by an intermediary data collector configured at least for listening to a plurality of agents, the agents comprising at least one of a file transfer protocol engine, file manager, or conversion interface.

15. A computer program product for monitoring an electronic data exchange between a client and a servicing system, the computer program product comprising at least one non-transitory computer-readable medium having computer-readable program instructions stored therein, the computer-readable program instructions comprising instructions, which when performed by an apparatus, are configured to cause the apparatus to perform at least:
loading a profile comprising information describing expected files to be received during a defined period;
logging information regarding receipt of files during the defined period in a tracking record;
comparing the tracking record to the profile; and
in an instance an expected file is not received during the defined period, generating a missing file notification.

16. The computer program product of claim 15, wherein the computer-readable program instructions further comprise instructions, which when performed by the apparatus, are configured to cause the apparatus to perform at least:
generating the profile by receiving user input describing the expected receipt, processing, and contents of a specified type of file; and
applying the user input to a template such that the profile is stored in a memory of the serving system.

17. The computer program product of claim 15, wherein the profile comprises an expected number of files of a given type to be received during the defined period, and the computer-readable program instructions further comprise instructions, which when performed by the apparatus, are configured to cause the apparatus to perform at least:
in an instance a number of received files of the given type does not match the expected number of files of the given type, generating a mismatch notification.

18. The computer program product of claim 15, wherein the profile indicates an expected order of files to be processed, and the computer-readable program instructions further comprise instructions, which when performed by the apparatus, are configured to cause the apparatus to perform at least:
in an instance files are not received in the expected order, generating an unexpected order notification.

19. The computer program product of claim 15, wherein the computer-readable program instructions further comprise instructions, which when performed by the apparatus, are configured to cause the apparatus to perform at least:
calculating a deadline for a reactive process to occur in association with at least one received file and based on the profile; and
in response to the deadline elapsing with no occurrence of the reactive process, generating process failure notification.

20. The computer program product of claim 15, wherein the computer-readable program instructions further comprise instructions, which when performed by the apparatus, are configured to cause the apparatus to perform at least:
storing a plurality of tracking records in association with the identified profile; and
generating reports describing the plurality of tracking records.
